(19) United States
(12) Patent Application Publication
(10) Pub. No.: US 2014/0160267 A1
(43) Pub. Date: Jun. 12, 2014

(54) Image Pickup Apparatus

(71) Applicant: CANON KABUSHIKI KAISHA, Tokyo (JP)

(72) Inventors: Tomoaki Kawakami, Utsunomiya-shi (JP); Kazuhiko Kajiyama, Utsunomiya-shi (JP); Toshihiko Tsuji, Utsunomiya-shi (JP); Masayuki Suzuki, Utsunomiya-shi (JP)

(73) Assignee: CANON KABUSHIKI KAISHA, Tokyo (JP)

(21) Appl. No.: 14/234,516

(22) PCT Filed: Jul. 10, 2012
(86) PCT No.: PCT/JP2012/068046

§ 371 Date: Jan. 23, 2014

(30) Foreign Application Priority Data
Jul. 25, 2011 (JP) 2011-162157

(51) Int. Cl. G02B 21/36; H04N 5/232

(52) U.S. Cl. CPC G02B 21/365; H04N 5/23212
USPC 348/79

(57) ABSTRACT

An image pickup apparatus includes a measuring section configured to measure a surface shape of an object, an image pickup section configured to obtain images of different areas of the object on an image plane of an image pickup optical system by image pickup elements, a focal-position detecting unit configured to detect a focal position of the object where a focal-position detecting point is focused on the image plane, and a focal-position determining unit configured to determine a focal position of the object at a point different from the focal-position detecting point on the basis of detection of the focal-position detecting unit and measurement of the measuring section. The image pickup section takes the images of the different areas on the basis of determination of the focal-position determining unit while the images are focused on the image pickup elements.

### TECHNICAL FIELD

The present invention relates to an image pickup apparatus, such as a digital microscope, which obtains an image of an object.

### BACKGROUND ART

In recent years, attention has been given to image pickup apparatuses that acquire, as computerized images, outer shape information from the entire sample and details of cellular tissues and display the computerized images on a monitor for observation.

This type of image pickup apparatus is characterized in that the size of an object is large (several millimeters to several tens of millimeters) in contrast to the resolution (<1 μm) of an objective lens necessary to observe the object. Accordingly, to form an image with a high resolution and a wide field of view, it is necessary to obtain one whole image by combining images of different portions of the object taken by an objective lens that has a narrow field of view, but has a high resolution.

However, when defocus is measured and focusing is performed for each portion of the object, it takes much time to obtain one whole image. Accordingly, PTL 1 discloses that focusing is performed at three or more points on a slide glass, which holds a sample (object), to obtain the tilt of the slide glass and that focal positions at points other than the three or more points are estimated by calculation. PTL 2 discloses that an area where a sample exists is obtained beforehand, focal positions at three reference points in the area are measured, and a focal position at an arbitrary position is calculated from a plane equation including the three points.

In PTL 1 and PTL 2, the plane equation including the three points on the surface of the object is obtained from the focal positions at the three points. However, the surface of an actual sample is not always flat. For this reason, an image obtained by the methods described in PTL 1 and PTL 2 may blur because the focal position at an arbitrary position is greatly displaced from an actual focal position, or more time may be taken because focusing is performed again.

### CITATION LIST

### Patent Literature

PTL 1 Japanese Patent No. 4332905
PTL 2 Japanese Patent Laid-Open No. 2004-191959

### SUMMARY OF INVENTION

An image pickup apparatus according to an aspect of the present invention includes: a measuring section configured to measure a surface shape of an object; an image pickup section configured to obtain images of different areas of the object formed on an image plane of an image pickup optical system by a plurality of image pickup elements; a focal-position detecting unit configured to detect a focal position of the object where a focal-position detecting point of the object is focused on the image plane; and a focal-position determining unit configured to determine a focal position of the object at a point different from the focal-position detecting point of the object on the basis of a detection result of the focal-position detecting unit and a measurement result of the measuring section. The image pickup section takes the images of the different areas of the object on the basis of a determination result of the focal-position determining unit in a state in which the images are focused on the plurality of image pickup elements.

### BRIEF DESCRIPTION OF DRAWINGS

FIG. 1 illustrates an overall configuration of an image pickup apparatus according to first and second embodiments.

FIG. 2 illustrates a sample section.

FIG. 3 illustrates the relationship among a sample position, an image pickup area, and a camera sample reference point.

FIGS. 4A and 4B illustrate a Shack-Hartmann wavefront sensor.

FIGS. 5A and 5B illustrate positions of imaging points in the Shack-Hartmann wavefront sensor.

FIG. 6 illustrates the relationship among the sample position, the image pickup area, and a sensor sample reference point.

FIG. 7 illustrates surface shape data at the sensor sample reference point and a different point.

FIGS. 8A and 8B illustrate a sample image on an image plane.

FIGS. 9A, 9B, and 9C illustrate a structure of a focus sensor unit and the principle of focusing.

FIGS. 10A, 10B, and 10C illustrate optical paths of illumination light and scattering light.

FIG. 11 illustrates an illumination method adopted to obtain a focal position.

FIG. 12 illustrates adjustment of the heights of image pickup elements according to a focal position.

FIGS. 13A to 13H illustrate acquisition of a whole image through a plurality of image pickup operations.

FIG. 14 illustrates a sample focusing procedure.

FIGS. 15A and 15B illustrate the relationship among a camera sample reference point, tilt detection points, and focus sensors.

FIG. 16 illustrates a sample focusing procedure.

FIG. 17 illustrates an overall configuration of an image pickup apparatus according to a third embodiment.

FIG. 18 illustrates a sample focusing procedure.

FIG. 19 illustrates an image pickup section including multiple focus sensors.

FIG. 20 illustrates an overall configuration of an image pickup apparatus according to a fourth embodiment.

FIG. 21 illustrates a sample focusing procedure.

### DESCRIPTION OF EMBODIMENTS

Image pickup apparatuses according to embodiments of the present invention will be described below.

### First Embodiment

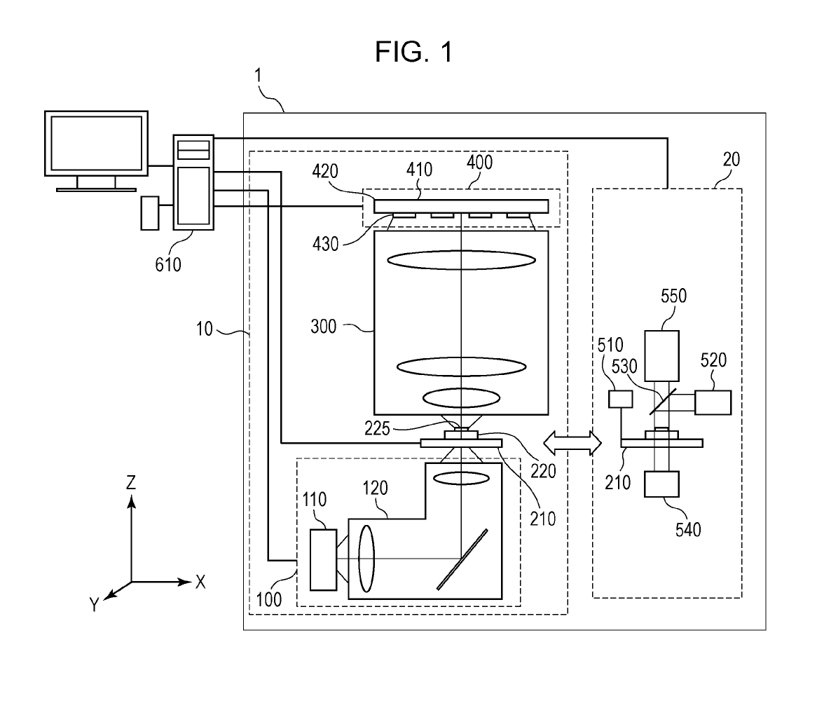

FIG. 1 schematically illustrates an image pickup apparatus 1 according to a first embodiment of the present invention. Referring to FIG. 1, the image pickup apparatus 1 includes a main image pickup system 10 serving as an image pickup section that takes an image at a high resolution and a wide field of view, and a measuring optical system 20 serving as a measuring section that measures a position and a surface shape of a sample to be observed.

The main image pickup system 10 includes an illumination optical system 100 that guides light from a light source unit 110 to an irradiated surface on which a sample 225 is placed, an image pickup optical system 300 that forms an image of the sample 225, and an image pickup element unit 400 in which a plurality of image pickup elements 430 are arranged on an image plane of the image pickup optical system 300. The measuring optical system 20 includes a position measuring device 510 that measures the position of a sample stage 210, a light source 520 that illuminates the sample 225, a half mirror 530, a camera 540 that measures the position of the sample 225, and a camera sensor 550 that measures the surface shape of the sample 225. For example, the sample 225 is placed between a slide glass and a cover glass (the glasses are not illustrated; sometimes the cover glass is not used) to form a prepared slide 220. The prepared slide 220 is placed on the sample stage 210, and is conveyed between the main image pickup system 10 and the measuring optical system 20 by the sample stage 210.

Hereinafter, the optical axis of the image pickup optical system 300 is referred to as a Z-direction, and a plane perpendicular to the optical axis of the image pickup optical system 300 is referred to as an XY-plane.

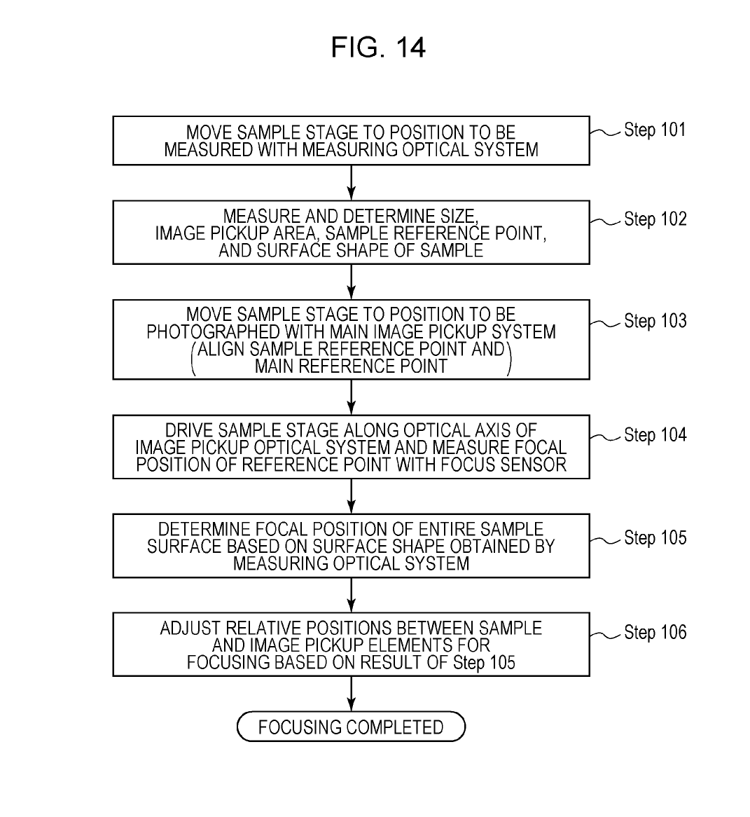

These structures will be described in detail along a procedure of FIG. 14 for obtaining a whole image of the sample after the prepared slide 220 is placed on the sample stage 210.

First, the sample 225 is placed at a position where the sample 225 can be measured with the measuring optical system 20 (Step 101).

Then, the measuring optical system 20 measures a size, an image pickup area, an image pickup position (sample reference point), and a surface shape of the sample 225 (Step 102).

The camera 540 takes an image of the sample 225 by using transmitted light of light applied from the light source 520 via the half mirror 530 in order to recognize the position of the sample 225 on the sample stage 210. The size, image pickup area, image pickup position, etc. of the sample 225 are thereby measured. The camera sensor 550 is a Shack-Hartmann wavefront sensor, and measures the surface shape of the sample 225. It is said that, when the cover glass is placed on the sample 225, the surface shape of the sample 225 changes along the surface shape of the cover glass. For this reason, when the cover glass is placed on the sample 225, the surface shape of the cover glass may be measured as the surface shape of the sample 225.

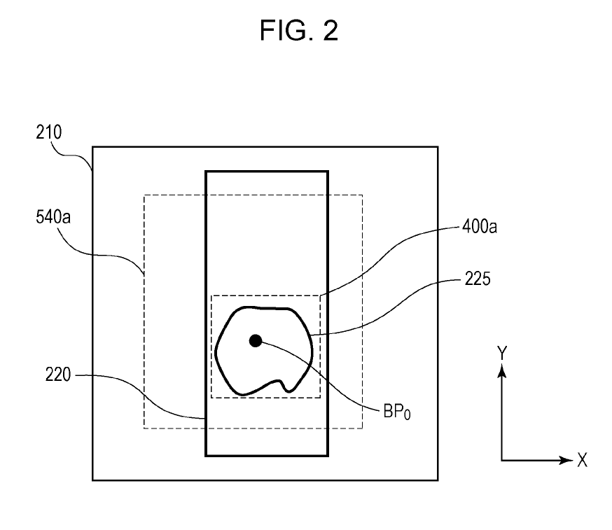

The sample stage 210 can change the position of the prepared slide 220 in the Z-, X-, and Y-direction or tilt the position of the prepared slide 220 with respect to the Z-direction, and is driven so that the sample 225 coincides with the irradiated surface. FIG. 2 illustrates, on the sample stage 210, positions of the prepared slide 220 and the sample 225, an area 540a to be photographed by the camera 540, an image pickup area 400a in a main image pickup operation, and a sample reference point BP₀. The image pickup area 400a in the main image pickup operation, the sample reference point BP₀, and the surface shape of the sample 225 are determined by a processing unit 610. The image pickup area 400a is determined by the size, shape, and position of the sample 225 and an area that can be photographed by the image pickup optical system 300.

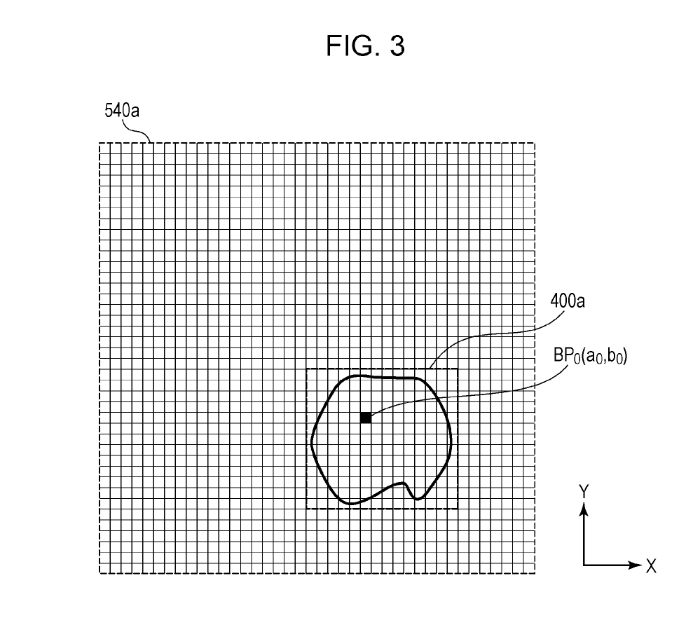

As illustrated in FIG. 3, the sample reference point BP₀ indicates a representative position of a sample, as viewed from the camera 540, and is determined as coordinates (a₀, b₀) of a photographed image after the image pickup area 400a is determined. For example, in a case in which a reference point of the main image pickup system 10 is set at the optical axis center of the image pickup optical system 300, the sample reference point BP₀ is determined at a position corresponding to the optical axis center of the image pickup optical system 300 when the image pickup area 400a determined in the measuring optical system 20 is aligned with the image pickup area of the main image pickup system 10. For this reason, the sample reference point BP₀ is determined according to a position of a predetermined reference point (main reference point) in the main image pickup system 10.

The stage drive amount is calculated, from positional relationship data among three points, namely, “a stage position (measured by the position measuring device 510)”, “image coordinates”, and “a reference position in the main image pickup system (main reference point)” that are obtained beforehand during assembly of the apparatus, so that the main reference point and the sample reference point BP° coincide with each other.

In this way, the image pickup area 400a in the main image pickup operation, the surface shape of the sample, and the position of the sample (sample reference point BP₀) are determined.

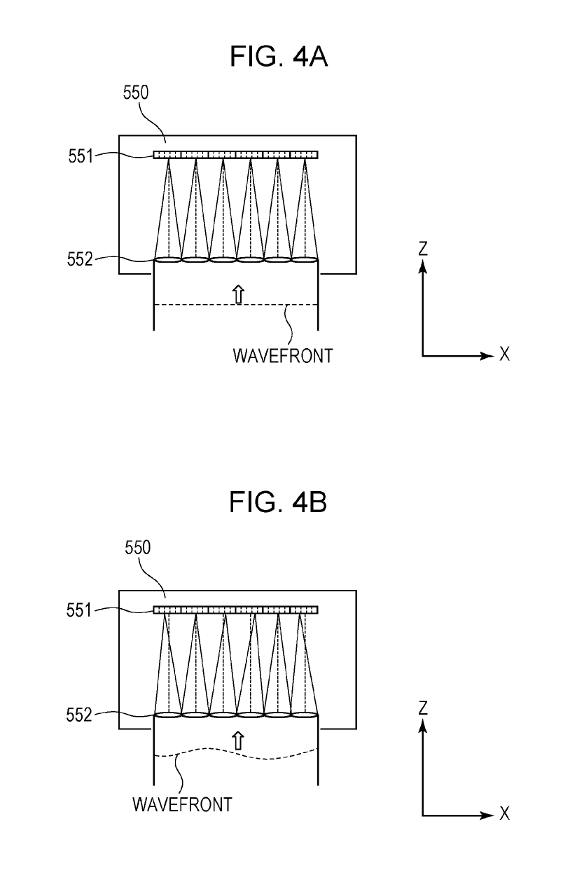

Next, a description will be given of a method for measuring the surface shape of the sample 225 or the cover glass with the camera sensor 550. As described above, the camera sensor 550 is a Shack-Hartmann wavefront sensor, and includes an image pickup element 551 and a microlens array 552, as illustrated in FIGS. 4A and 4B. The camera sensor 550 receives reflected light from the sample 225 or the cover class illuminated by the light source 520 and the half mirror 530. At this time, light incident on the microlens array 552 of the camera sensor 550 forms a plurality of point images on the image pickup element 551. When the reflected light from the sample 225 or the cover glass is ideal and is not distorted, the point images are arranged at regular intervals, as illustrated in FIG. 4A. In contrast, when a part of a surface of the sample 225 is distorted, reflected light from the part is focused on a position misaligned with ideal point image positions, as illustrated in FIG. 4B.

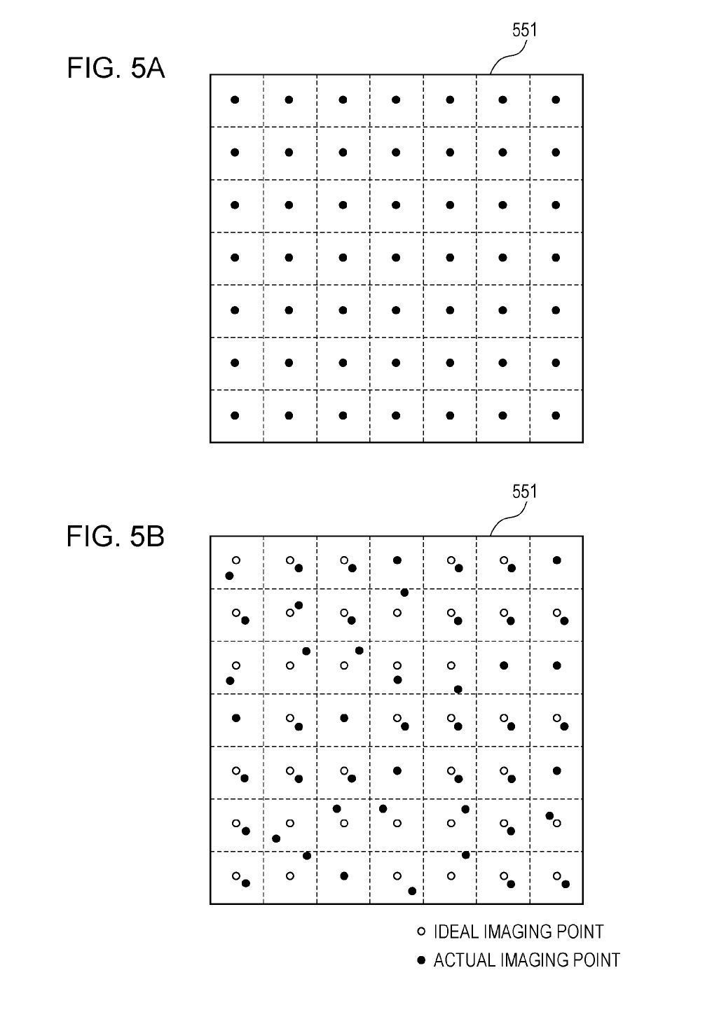

When the surface of the sample 225 or the cover glass is ideally flat, imaging points shown by closed circles are regularly arranged on the image pickup element 551, as illustrated in FIG. 5A. In contrast, when the surface of the sample 225 (surface of the object) is partially distorted, imaging points are not aligned with ideal imaging points shown by open circles, as illustrated in FIG. 5B. Differences between ideal imaging points and actual imaging points indicate the tilt of the surface of the sample 225 or the cover glass with respect to the ideal flat surface. For this reason, irregularities in the Z-direction of the surface of the sample or the cover glass can be recognized by connecting the differences at the measurement points, and the surface shape of the sample 225 or the cover glass can be acquired. In this way, information about the positions in the directions (X-, Y-directions) orthogonal to the optical axis of the image pickup optical system 300 and the positions in the direction (Z-direction) parallel to the optical axis at a plurality of different points on the surface of the sample 225 is acquired.

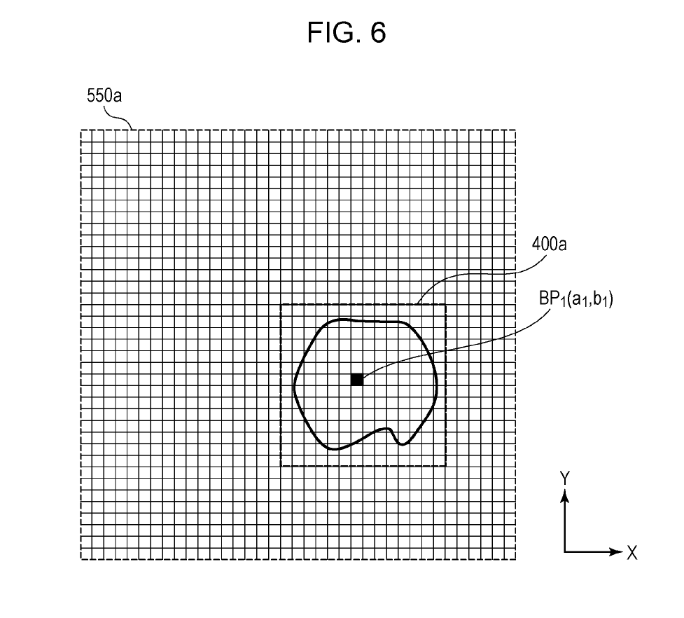

FIG. 6 illustrates the relationship on the image pickup element 551 among the sample position, the imaging point position, a sample reference point BP₁, and an area 550a to be observed by the camera sensor 550. The sample reference point BP₁ represents a representative position of a sample, as viewed from the camera sensor 550. Hereinafter, to distinguish from the sample reference point BP₀ serving as a representative position of the sample viewed from the camera 540, the sample reference point BP₀ is referred to as a camera sample reference point BP₀, and the sample reference point BP₁ is referred to as a sensor sample reference point BP₁.

Similarly to the camera sample reference point BP₀, the sensor sample reference point BP₁ is determined so that the image pickup area in the main image pickup system 10 coincides with the image pickup area 400a determined by the measuring optical system 20. That is, the sensor sample reference point BP₁ is determined at a position corresponding to the camera sample reference point BP₀ in the image pickup area 400a. For this reason, the sensor sample reference point BP₁ is uniquely determined by determining the camera sample reference point BP₀.

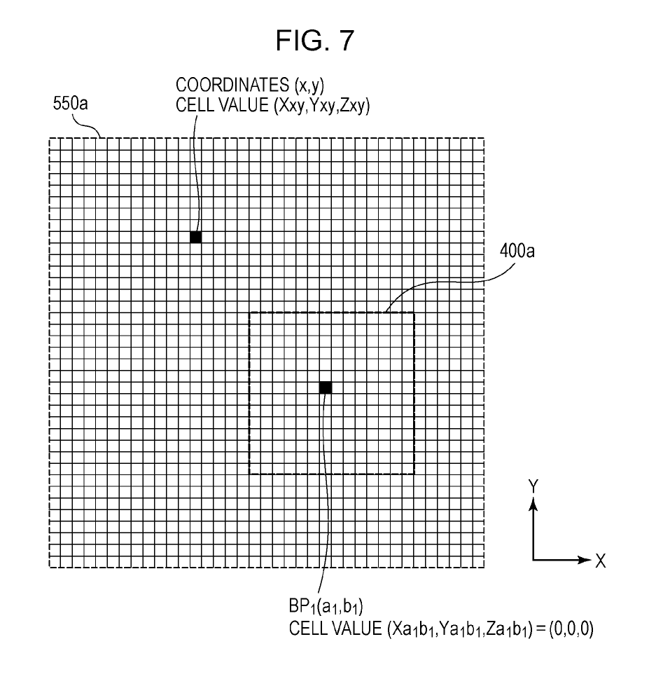

Here, the coordinates of the sensor sample reference point BP₁ is taken as (a₁, b₁). At this time, for example, as illustrated in FIG. 7, the sensor sample reference point BP₁ is expressed by data (Xa₁b₁, Ya₁b₁, Za₁b₁)=(0, 0, 0). A point different from the sensor sample reference point BP₁ is expressed by data on a defocus amount (Xxy, Yxy, Zxy) from the sensor sample reference point BP₁. Here, lower case letters x and y indicate the column and the line of the cell in surface shape data. In this way, the surface shape of the sample 225 is measured and acquired.

Next, to take an image of the sample 225, the sample stage 210 is driven so that the camera sample reference point BP₀ coincides with the main reference point (Step 103).

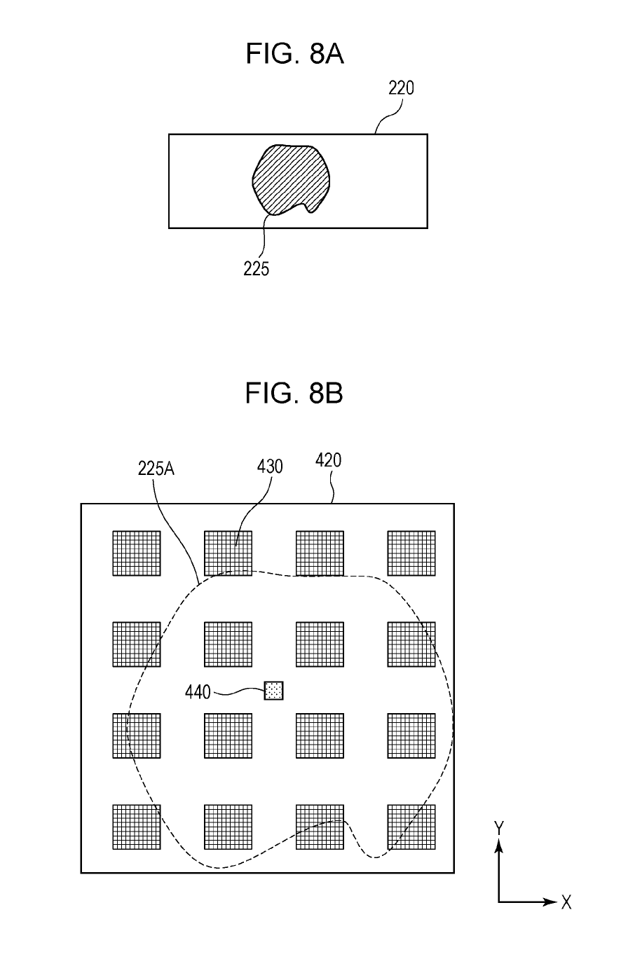

Referring again to FIG. 1, details of the main image pickup system 10 will be described below. The illumination optical system 100 superimposes light emitted from the light source unit 110 by an optical integrator unit 120, and illuminates the entire surface of the sample 225 with uniform illuminance. The light source unit 110 emits a light beam for illuminating the sample 225, and for example, is formed by one or a plurality of halogen lamps, xenon lamps, or LEDs. The image pickup optical system 300 forms an image of the illuminated sample 225 on the image plane in a wide field of view and at a high resolution. An image of the sample 225 illustrated in FIG. 8A is formed as an image 225A shown by a dotted line in FIG. 8B by the image pickup optical system 300.

The image pickup element unit 400 includes an image pickup stage 410, an electric circuit board 420, image pickup elements 430, and a focus sensor 440. As illustrated in FIG. 8B, the image pickup elements 430 are arranged on the electric circuit board 420 at intervals in a manner such as to be aligned with the image plane of the image pickup optical system 300 on the image pickup stage 410. The focus sensor 440 is a focal-position detecting unit that detects a focal-position detecting point of the sample 225. The focus sensor 440 is provided on the electric circuit board 420, and functions as a main reference point used to align the main image pickup system 10 and the measuring optical system 20.

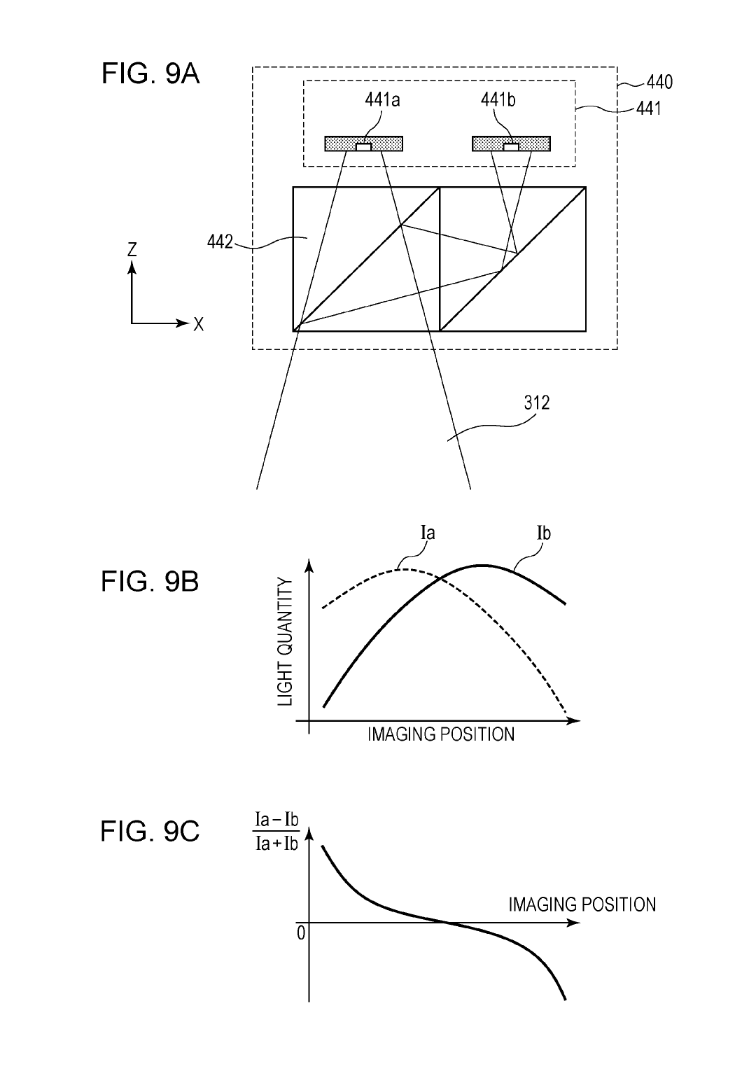

For example, the focus sensor 440 may be a two-dimensional image pickup element that can process the contrast of an image of a uniformly illuminated sample at high speed, or may be formed by a plurality of actinometers to determine the focal position by the light quantity. Here, a description will be given of a structure of the focus sensor 440 for acquiring focal-position information and a focal-position acquisition method adopted when a plurality of actinometers are used, with reference to FIGS. 9A to 9C. As illustrated in FIG. 9A, the focus sensor 440 splits light 312 from the image pickup optical system 300 by a half prism 442, and obtains light quantities at different positions by a light-quantity sensor unit 441. Light receiving surfaces 441a and 441b of two light-quantity sensors in the light-quantity sensor unit 441 have a size substantially equal to the minimum spot size to be formed by the image pickup optical system 300. This gives the same effect as a pinhole effect to the light receiving surfaces 441a and 441b. Further, the two light receiving surfaces 441a and 441b are adjusted to be at an equal distance from the image plane of the image pickup optical system 300 so that the image plane of the image pickup optical system 300 coincides with the imaging position of the sample 225 when the light receiving surfaces 441a and 441b detect the same light quantity.

In FIG. 9B, the vertical axis indicates light quantity of incident light that changes according to the imaging position. A dotted line and a solid line represent quantities Ia and Ib of light incident on the two light receiving surfaces 441a and 441b, respectively. The horizontal axis indicates the imaging position. In FIG. 9C, the vertical axis indicates (Ia−Ib)/(Ia+Ib), and the horizontal axis indicates the imaging position. As illustrated in FIG. 9B, the curves of the quantities of light incident on the light-quantity sensors have the same peak shape. At this time, as illustrated in FIG. 9C, (Ia−Ib)/(Ia+Ib) is 0 at a certain imaging position, which shows that the focus sensor 440 coincides with the imaging position of the sample 225. A front focus state is brought about when (Ia−Ib)/(Ia+Ib) is a positive value, and a rear focus state is brought about when (Ia−Ib)/(Ia+Ib) is a negative value. Thus, imaging position information can be quantitatively measured on the basis of the difference or ratio of the quantities of light received by the two light-quantity sensors in the light quantity sensor unit 441.

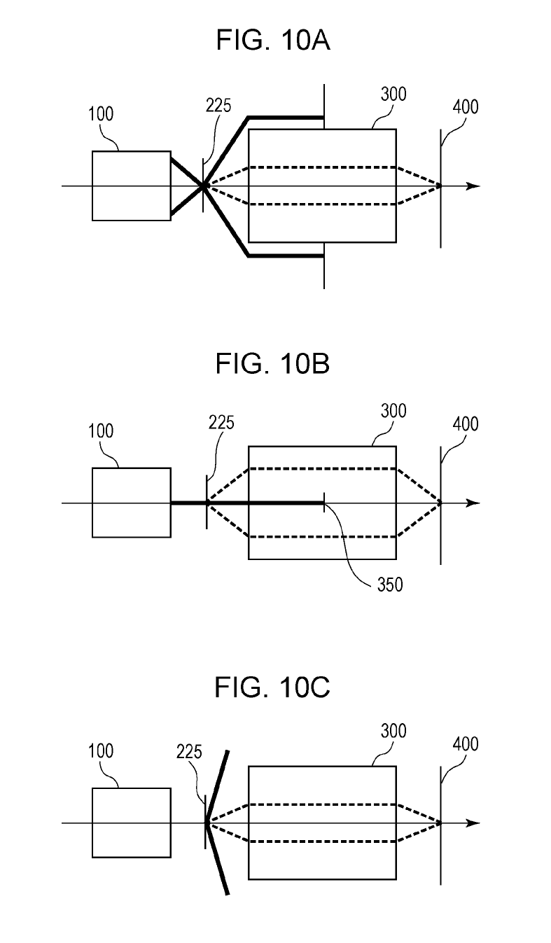

When acquiring the focal-position information, reliability can be enhanced by obtaining only scattering light from the sample 225 as dark-field illumination. For example, only scattering light from the sample 225 can be acquired by setting the numerical aperture NA of the illumination optical system 100 to be larger than the numerical aperture NA of the image pickup optical system 300 so that illumination light does not enter the image pickup optical system 300. FIG. 10A schematically illustrates the illumination light by a solid line and the scattering light by a dotted line in this case. Alternatively, when illumination light from the illumination optical system 100 is made closely parallel to the optical axis of the image pickup optical system 300 and is blocked by a light blocking unit 350 at a pupil plane of the image pickup optical system 300 or the like, only scattering light from the sample 225 can also be obtained. FIG. 10B schematically illustrates the illumination light by a solid light and the scattering light by a dotted line in this case.

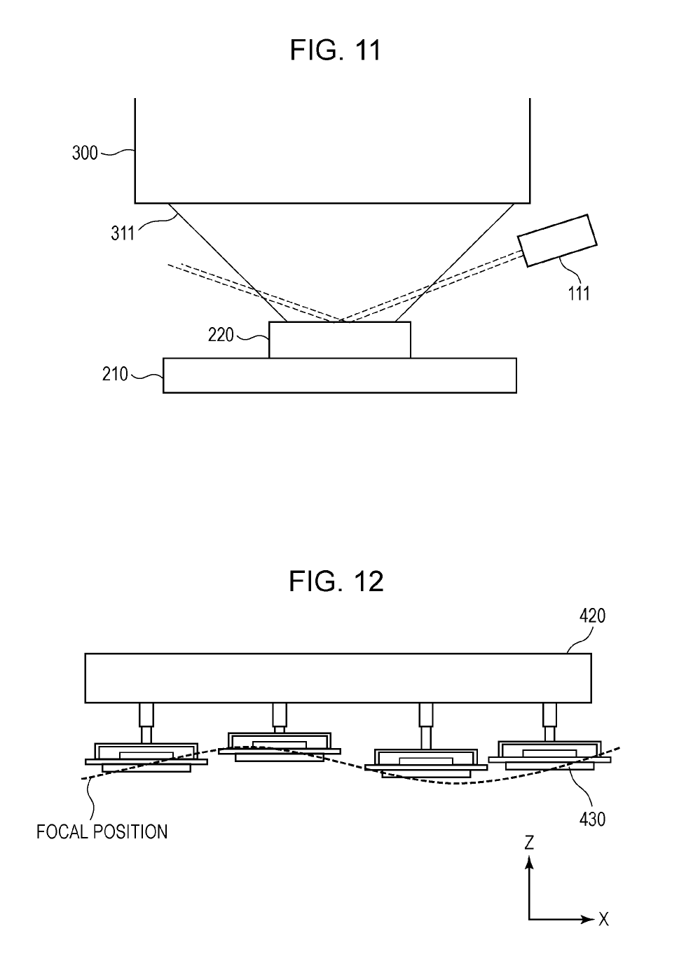

Further alternatively, as illustrated in FIG. 11, an illumination optical system 111 different from the illumination optical system 100 is prepared, and illumination light is obliquely applied at an angle more than an area 311 that can be captured by the image pickup optical system 300. Then, reflected light from the sample section is not captured by the image pickup optical system 300, but only scattering light from the sample 225 can be obtained. FIG. 10C schematically illustrates the illumination light by a solid line and the scattering light by a dotted line in this case.

Further, any of a plurality of image pickup elements 430 may be selected as a focus sensor instead of using the sensor only for focusing, a specific pixel in the selected image pickup element may be set as a main reference point, and focusing may be performed by using the above-described method.

By the above-described structure and method, a focal position is determined by the focus sensor 440.

A focal position of the sample 225 at the camera sample reference point BP₀ is found with the focus sensor 440 while moving the sample stage 210 in the Z-direction (Step 104).

Here, the sample 225 is placed so that the camera sample reference point BP₀ and the focus sensor unit 440 have a conjugated positional relationship with the image pickup optical system 300. An image of the sample 225 is sometimes taken with focus not only on the surface of the sample 225 but also on the inside of the sample 225. Hence, the focal position detecting point can be set not only on the surface of the sample 225 but also in the sample 225.

After focus is obtained at the camera sample reference point BP₀, the surface shape data obtained by the measuring optical system 20 is applied to the entire sample 225 (Step 105).

First, the camera sample reference point BP₀ and the main reference point are caused to have a focus relationship between an object point and an image point in the image pickup optical system 300. In portions other than the camera sample reference point BP₀, focal positions are determined by the processing unit 610 serving as the focal-position determining unit on the basis of the detection result of the focus sensor 440 and the surface shape data obtained beforehand. At this time, when the sensor sample reference point BP₁ is set at a position corresponding to the camera sample reference point BP₀ in the image pickup area 400a, the surface shape data obtained beforehand is applied with reference to the focal position at the camera sample reference point BP₀. That is, the focal position at the camera sample reference point BP₀ is caused to correspond to the sensor sample reference point BP₁ serving as the reference point of the surface shape data, and the difference (surface shape) from the sensor sample reference point BP₁ is applied as the defocus amount in the Z-direction, thereby determining the focal position of the entire surface of the sample. When the sensor sample reference point BP₁ is set at a position different from the position corresponding to the camera sample reference point BP₀, the position corresponding to the camera sample reference point BP₀ in the surface shape data is caused to correspond to the focal position at the camera sample reference point BP₀. Then, the surface shape data is applied to the entire surface of the sample.

By doing this, the focal position can be obtained from the surface to the inside of the sample 225 by a small number of focusing operations. However, as for the defocus amount on the image pickup section side, the optical (lateral) magnification β of the image pickup optical system 300 is considered. As an example, it is assumed that the image pickup optical system forms images an add number of times and a defocus zxy from the sensor sample reference point BP₁ is provided at an arbitrary point (Xxy, Yxy) on the sample. In this case, on the image plane side, a defocus Zxy×β² is applied at a point (−Xxy×β, −Yxy×β) on the XY-plane.

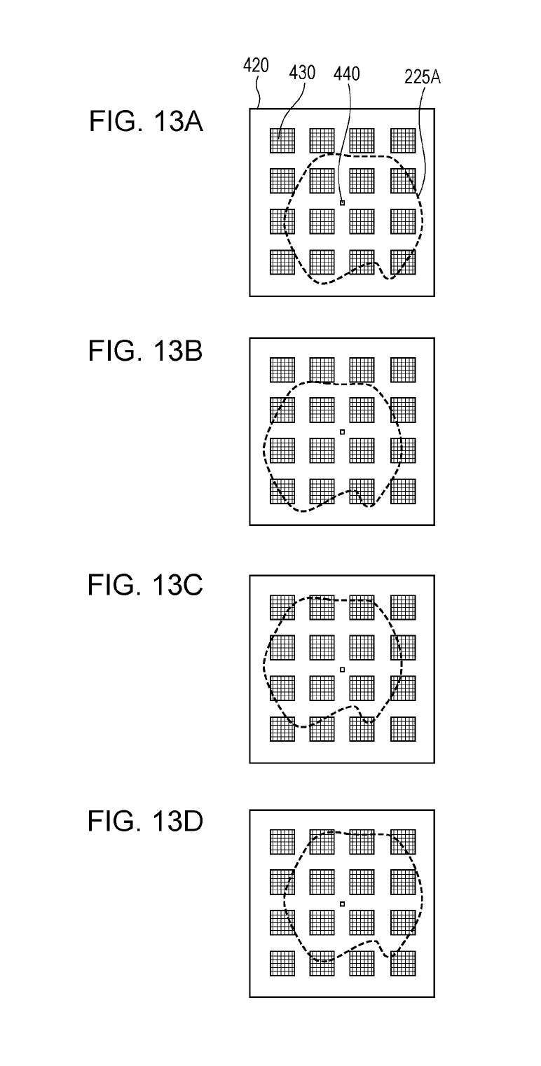

When the entire surface is actually focused, the relative positions between the sample stage 210 and the image pickup elements 430 are changed so that the sample stage 210 and the image pickup elements 430 have a conjugated relationship (Step 106). For example, as illustrated in FIG. 12, the image pickup elements 430 are structured to be driven in the Z-direction and rotatable about the X and Y axes. The image pickup elements 430 are driven according to the determined focal position in consideration of the surface shape and the magnification β so that imaging can be performed with the sample 225 in focus. To minimize the defocus amount of the entire sample, the sample stage 210 may be driven in the Z-direction and tilted with respect to the X and Y axes.

Through the above-described procedure, the entire surface is focused and an image is obtained. Since a plurality of image pickup elements 430 are separately arranged in the image pickup section of the first embodiment, a whole image of the sample cannot be taken in one image pickup operation. For this reason, it is necessary to form a whole image of the sample by performing image pickup operations while moving the sample 225 and the image pickup element unit 400 relative to the plane perpendicular to the optical axis direction of the image pickup optical system 300 and combining obtained separate images.

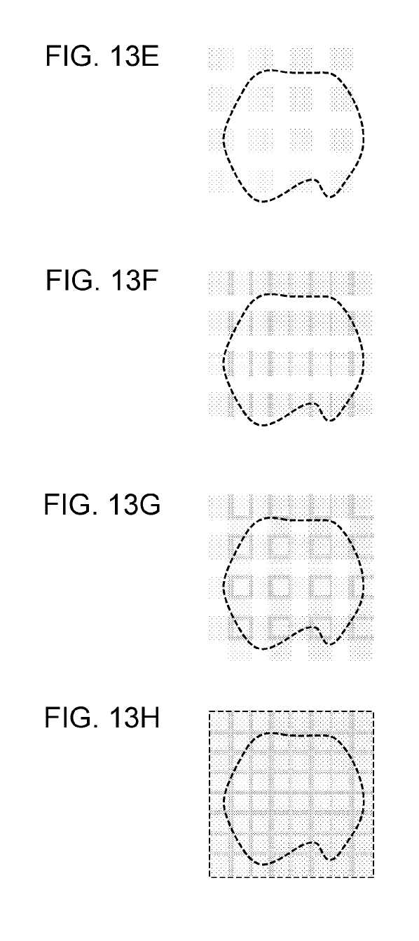

Hereinafter, a description will be given of the relationship between the motion of the sample 225 and the sample stage 210, and the image pickup optical system 300 and the image pickup element unit 400 when the entire sample is taken as one image. FIGS. 13A to 13H illustrate a case in which a plurality of image pickup elements 430 are arranged in a grid pattern, images are taken while shifting the sample section 200 three times on the XY-plane, and the taken images are combined. FIGS. 13A to 13D illustrate the relationship between the image pickup elements 430 and a sample image 225A when images are taken while shifting the sample stage 210 in a direction perpendicular to the optical axis of the image pickup optical system 300 so as to fill gaps between the image pickup elements 430.

When the first image pickup operation is performed at a position of FIG. 13A, only areas (shaded portions) of an image 225A of the sample 225 where the image pickup elements are provided are separately taken, as illustrated in FIG. 13E. Next, when the sample stage 210 is shifted and the second image pickup operation is performed at a position of FIG. 13B, images of shaded portions of FIG. 13F including the previously taken images are obtained. When the sample stage 210 is further shifted and the third image pickup operation is performed at a position of FIG. 13C, images of shaded portions of FIG. 13G including the previously taken images are obtained. When the sample stage 210 is further shifted and moved to a position of FIG. 13D and images are taken, the taken images are superimposed on the images obtained by the three previous image pickup operations, so that a whole image of the image pickup area can be formed, as illustrated in FIG. 13H.

In this way, the whole image of the sample is obtained. To obtain an in-focus image, focusing is performed through Steps 104 to 106 of FIG. 14 in each of the four image pickup operations.

By the method described above, an in-focus and high-resolution whole image is formed by using the optical system with a wide angle of view and a plurality of image pickup elements.

According to the above-described method, it is possible to more accurately determine the focal position of the object at an arbitrary position and to obtain a whole image of the object in a shorter time.

### Second Embodiment

In the first embodiment, the surface shape of the sample 225 is measured, and the camera sample reference point BP₀ is aligned with the main reference point. The focal position of the image pickup optical system is determined at the camera sample reference point BP₀, and the image pickup elements or the like are driven along undulation of the surface shape, so that the focal positions are also determined at a plurality of points other than the point BP₀, and an in-focus whole image of the sample is obtained.

However, if the prepared slide 220 is tilted by impact or the like during transportation from the measuring optical system 20 to the main image pickup system 10, there is a need to correct the tilt. In this case, an in-focus whole image of the sample may be obtained by calculating the tilt of the sample 225 from focal positions measured by three or more focus sensors that are arranged in the image pickup element unit 400 such as not to be aligned in a straight line and by correcting the tilt by the sample stage 210.

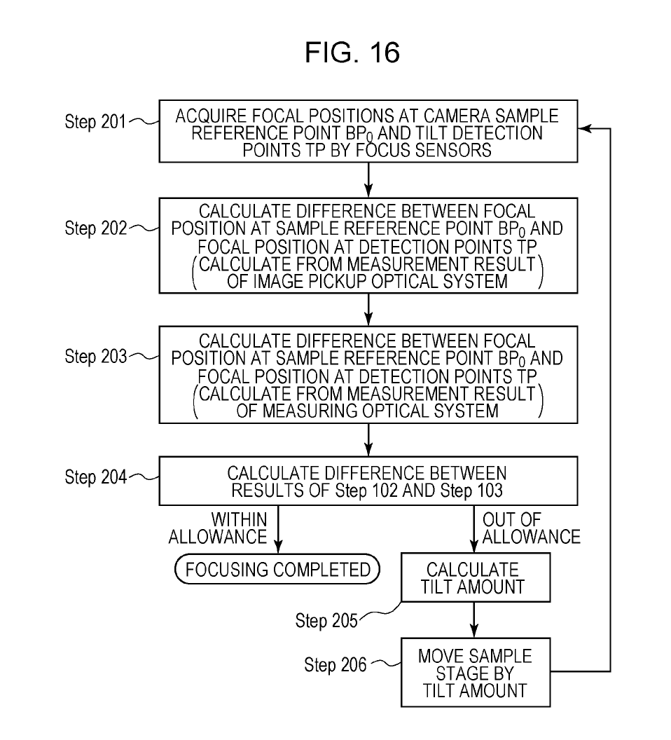

A focusing method adopted in this case will be described along a focusing procedure shown in FIG. 16. Here, descriptions of the same steps as those in the image pickup procedure of the first embodiment are skipped, and only steps for focusing the sample 225 are described.

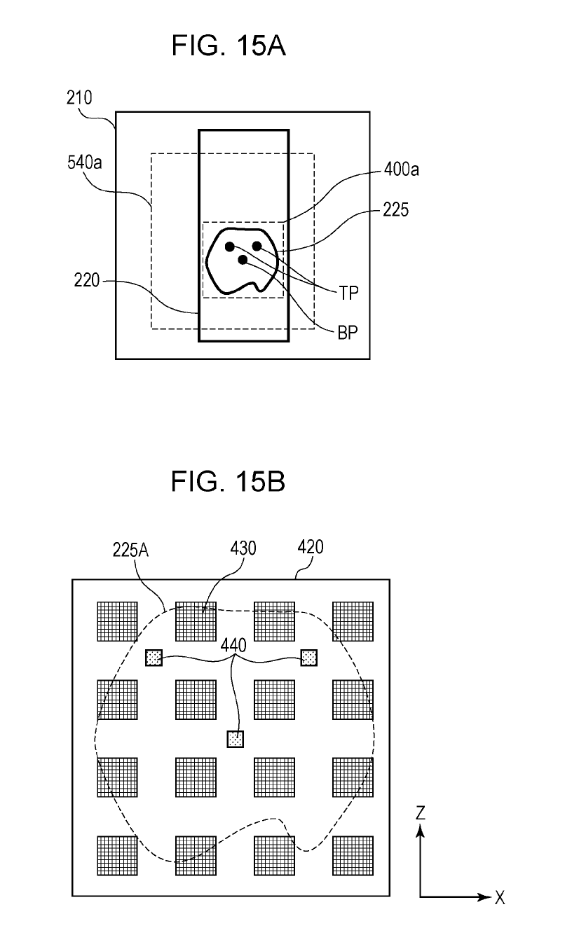

One of the three reference points serves as a camera sample reference point BP₀ that is the basis of the focal position of the entire sample, and the other reference points serve as tilt detection points TP (FIG. 15A). First, a sample stage 210 is driven in the Z-direction, and focal positions at the camera sample reference point BP₀ and the tilt detection points TP are acquired by focus sensors 440 (Step 201).

Next, a difference between the focal position at the camera sample reference point BP₀ and the focal positions (Z-direction) at the tilt detection points TP when the focal position at the camera sample reference point BP₀ is determined is calculated (Step 202).

Then, a difference between the focal positions (Z-direction) at the camera sample reference point BP₀ and the tilt detection points TP is calculated from the surface shape measured by a measuring optical system 20 beforehand (Step 203).

The differences in focal position between Step 202 and Step 203 are compared (Step 204). When the comparison result is within a predetermined range, tilt correction is not performed by the sample stage 210, and focusing is completed. When the comparison result is out of the predetermined range, a tilt amount is calculated (Step 205).

The sample stage 210 is driven according to the tilt amount calculated in Step 205 to correct the tilt so that the difference in focal position (Z-direction) between the camera sample reference point BP₀ and the tilt detection points TP falls within the predetermined range (Step 206).

By the above-described steps, the surface shape of the sample 225 is measured, the focal position at the camera sample reference point BP₀ is adjusted, the defocus amount is calculated according to the surface shape (undulation), and the tilt is corrected by driving the sample section 200, so that an in-focus whole image of the sample can be obtained. When the tilt is large, the procedure may return from Step 206 to Step 201, and the same steps may be repeated.

This allows more accurate focusing.

### Third Embodiment

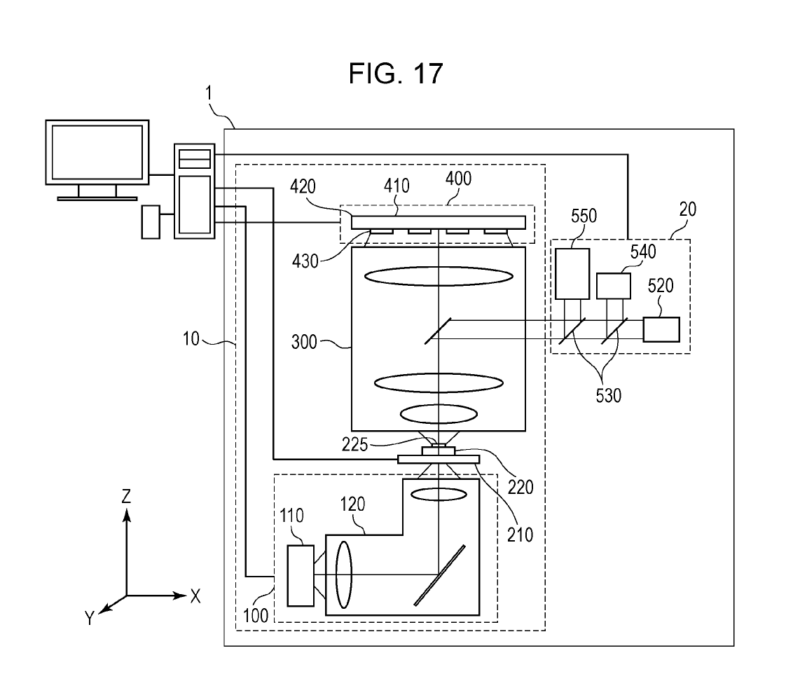

In the first embodiment and the second embodiment, the optical axes of the image pickup optical system and the measuring optical system are different. For example, as illustrated in FIG. 17, the optical axis of the image pickup optical system may be split by a half mirror or the like, and the optical axes of the optical systems may partially coincide with each other. In this case, a sample 225 is illuminated with light from a light source 520 in the measuring optical system, and an image of the sample 225 is taken by a camera 540. Also, the surface shape of the sample 225 is measured with a camera sensor 550.

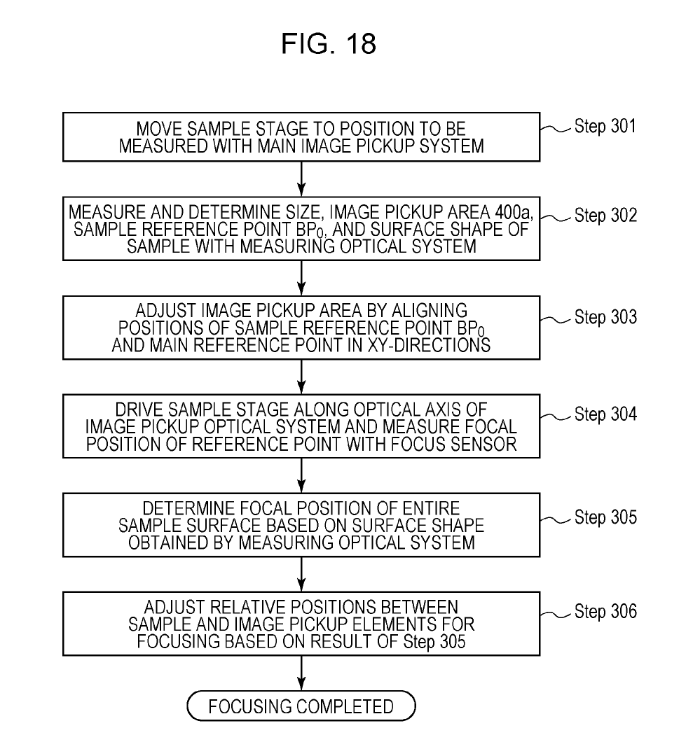

A focusing method adopted in this case will be described along a focusing procedure shown in FIG. 18. First, a sample stage 210 is placed at a position to be measured with a main image pickup system 10 (Step 301), and a size, an image pickup area 400a, a camera sample reference point BP₀, and a surface shape of a sample 225 placed on the sample stage 210 are measured with a measuring optical system 20 (Step 302).

Next, a sample stage 210 is driven on the XY-plane to adjust the image pickup area of the sample 225 so that the camera sample reference point BP₀ and a focus sensor (main reference point) have a conjugate positional relationship with an image pickup optical system 300 (Step 303).

Then, a focal potion at the camera sample reference point BP₀ is found with the focus sensor while driving the sample stage 210 in the Z-direction (Step 304). At this time, the sample 225 is placed so that the camera sample reference point BP₀ and the focus sensor have a conjugate positional relationship with the image pickup optical system 300.

As described in Step 105 of the first embodiment, after focus is obtained at the camera sample reference point BP₀, surface shape data obtained by the measuring optical system 20 is applied to the entire sample while the main reference point and a sensor sample reference point BP₁ serving as a reference point of the surface shape data are aligned (Step 305).

To focus the entire sample, the relative positions between the sample stage and the image pickup elements are changed so that the sample stage and the image pickup elements have a conjugate positional relationship (Step 306).

In Steps 304 to 306, a tilt detection operation may be performed with a plurality of focus sensors, similarly to the second embodiment.

The above method allows a whole image of the sample to be accurately formed in a short time.

### Fourth Embodiment

In the first to third embodiments, the surface shape of the sample is measured with the Shack-Hartmann wavefront sensor, the focus is adjusted at the reference point in the main image pickup system, and the focal position of the entire sample is indirectly determined on the basis of the measured surface shape.

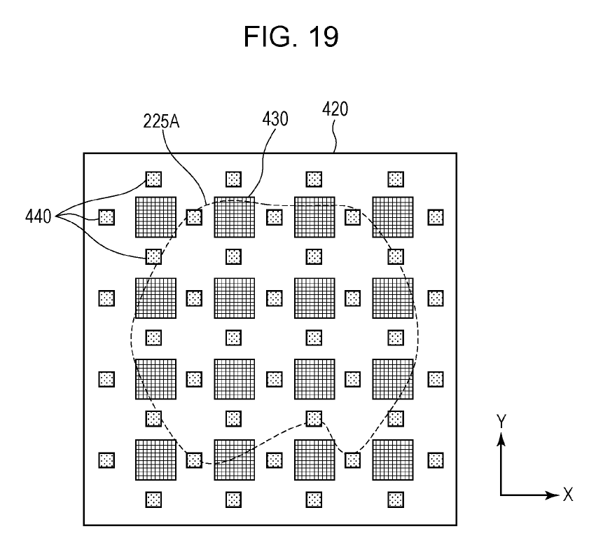

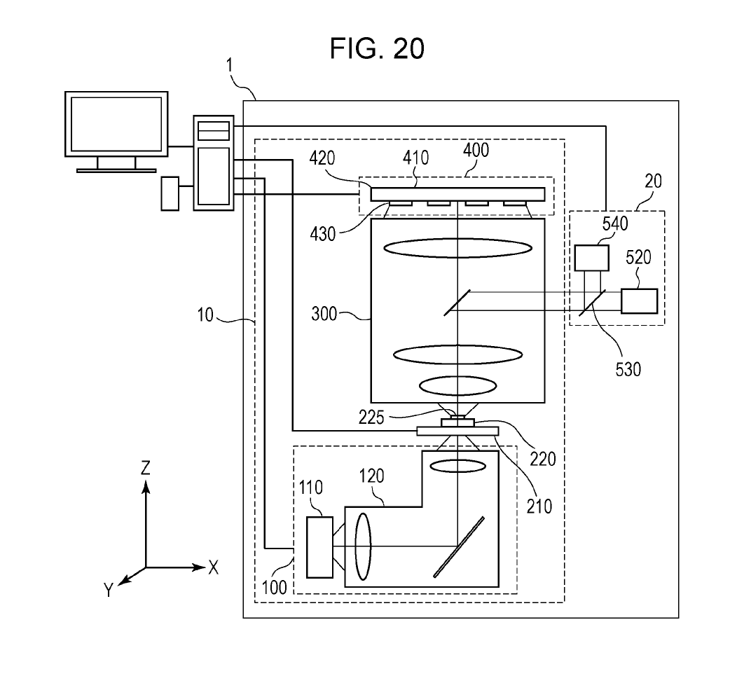

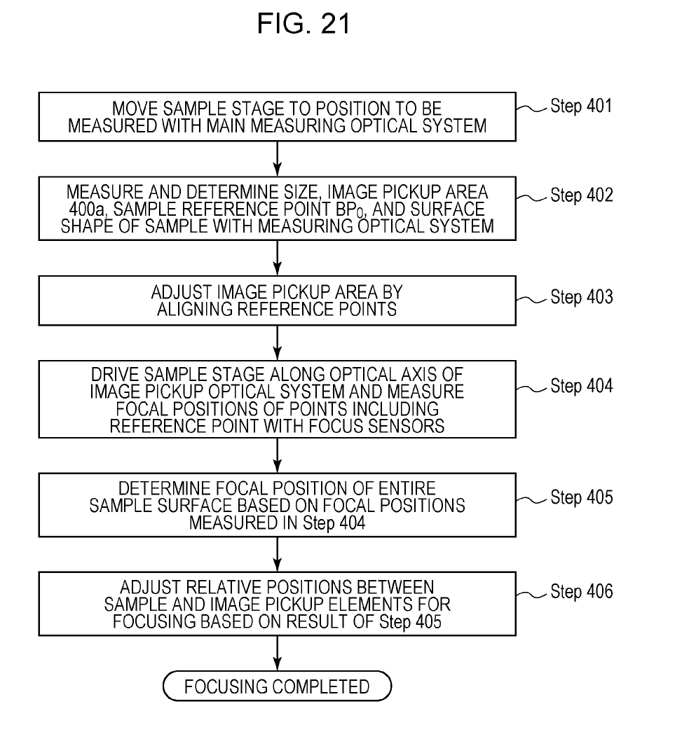

As illustrated in FIG. 19, a plurality of focus sensors 440 may be provided between image pickup elements 430 in an image pickup element unit 400, and the focal position may be measured only with the focus sensors 440. A focusing method adopted in this case will be described with reference to FIG. 20 illustrating an overall configuration view and FIG. 21 illustrating a focusing procedure.

First, a sample stage 210 is placed at a position to be measured with a main image pickup system 10 (Step 401), and a size, an image pickup area 400a, a camera sample reference point BP₀, and a surface shape of a sample 225 are measured with a measuring optical system 20 (Step 402).

Next, a sample stage 210 is driven in the Z-direction to adjust an image pickup area so that the camera sample reference point BP₀ and the focus sensors 440 (main reference point) have a conjugate positional relationship with an image pickup optical system 300 (Step 403).

Then, a focal position of the sample 225 at the camera sample reference point BP₀ is found while driving the sample stage 210 in the Z-direction of the image pickup optical system 300, and focal positions are also measured with the focus sensors 440 placed at positions that are not conjugate with the camera sample reference point BP₀ (Step 404).

Then, a focal position of the entire surface, including portions where the focus sensors 440 are not provided, can be calculated from the focal positions measured at a plurality of points (Step 405).

To apply the calculated focal position to the focal position of the entire surface, the relative positions between the sample and the image pickup elements are changed so that the sample and the image pickup elements have a conjugate positional relationship (Step 406).

In Step 404, to accurately find the focal position, the accuracy in focusing the entire surface may be increased by calculating focal positions with the focus sensors as the sample stage 210 is driven in the XY-plane so as to increase the number of focal-position measuring points.

In the above-described embodiments, the image pickup apparatus of the present invention is applied to the microscope. While the transmissive optical system that focuses transmitted light of light applied to the sample onto the image plane is adopted in the embodiments, an epi-illumination optical system may be adopted.

While some embodiments have been described, images of a plurality of samples can be taken in a short time by performing operations in parallel (simultaneously) in the main image pickup system and the measuring optical system as in the first embodiment and the second embodiment. That is, the measuring optical system measures the surface shape of a first sample, and at the same time, the main image pickup system takes an image of a second sample.

When the image pickup apparatus takes images of a small number of samples, it can be made compact by partially aligning the optical axes of the main image pickup system and the measuring optical system as in the third embodiment and the fourth embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-162157, filed Jul. 25, 2011, which is hereby incorporated by reference herein in its entirety.

1. An image pickup apparatus comprising:
a measuring section configured to measure a surface shape of an object;
an image pickup section configured to obtain images of different areas of the object formed on an image plane of an image pickup optical system by a plurality of image pickup elements;
a focal-position detecting unit configured to detect a focal position of the object where a focal-position detecting point of the object is focused on the image plane; and
a focal-position determining unit configured to determine a focal position of the object at a point different from the focal-position detecting point of the object on the basis of a detection result of the focal-position detecting unit and a measurement result of the measuring section,
wherein the image pickup section takes the images of the different areas of the object on the basis of a determination result of the focal-position determining unit in a state in which the images are focused on the plurality of image pickup elements.

2. The image pickup apparatus according to claim 1,
wherein the measuring section acquires information about positions in a direction orthogonal to an optical axis of the image pickup optical system and positions in a direction of the optical axis at a plurality of different points on a surface of the object, and
wherein the focal-position determining unit determines the focal position of the object at the point different from the focal-position detecting point by correcting the information with reference to the focal position at the focal-position detecting point.

3. The image pickup apparatus according to claim 1, wherein surface shape measurement of a first sample serving as the object in the measuring section and image pickup of a second sample different from the first sample in the image pickup section are performed in parallel.

4. The image pickup apparatus according to claim 1, wherein the measuring section measures the surface shape of the object with a Shack-Hartmann wavefront sensor.
